(19) United States
(12) Patent Application Publication
(10) Pub. No.: US 2008/0109867 A1
(43) Pub. Date: May 8, 2008

(54) SERVICE AND POLICIES FOR COORDINATING BEHAVIORS AND CONNECTIVITY OF A MESH OF HETEROGENEOUS DEVICES

(75) Inventors: Ruston John David Panabaker, Bellevue, WA (US); Eric Horvitz, Kirkland, WA (US); Alexander Frank, Bellevue, WA (US); Scott C. Forbes, Redmond, WA (US)

Correspondence Address: MICROSOFT CORPORATION, ONE MICROSOFT WAY, REDMOND, WA, 98052-6399, US

(73) Assignee: Microsoft Corporation, Redmond, WA (US)

(21) Appl. No.: 11/557,461

(22) Filed: Nov. 7, 2006

(51) Int. Cl. G06F 21/00

(52) U.S. Cl. 726/1

(57) ABSTRACT

A method and apparatus is provided for coordinating devices in a federated network of devices. A server may determine policies for coordinating the devices and may send messages to devices in the federated network for providing a service. The policies for providing the service among the federated devices may be based on properties of the devices or relative locations of the devices. For example, the federated devices may provide media data and control of the media data to a user. Provision of the media data and/or control of the media data may change from one device to another in the federated network based on policies from the server.

### BACKGROUND

Users typically desire access to data as well as the capability to manipulate data. To accomplish this goal, users employ a host of electronic devices to receive, transmit, or manipulate data. Certain devices are better designed for certain types of data management while being potentially less useful for other types of data management. For example, a user may wish to view digital content. While the user may view the digital content on a mobile device while roaming, the user may prefer to experience the digital content on a larger device such as on a large display in a media center. Conversely, if the user receives the digital content on a large device for receiving digital content, the user may be unable to roam while simultaneously experiencing the digital content.

Control of data delivery may be important to the user. For example, while receiving digital content, the user may wish to adjust the content, volume, or other characteristics of the received content. However, certain devices may be better equipped to control data delivery than others. For example, controlling the delivery of media on a small mobile device may be difficult to manipulate due to the small size of the mobile device. However, controlling the delivery of media on a large device may preclude user mobility while receiving the media.

Devices may be organized in a federation such that the devices may form an ad hoc network of devices. However, when devices are combined in a network, there is limited coordination of device activity to permit the devices to function in an integrated fashion. Rather, each of the devices in a federated network may function independently despite being in a federated network. As independent devices, activities of each of the devices are carried out by the respective devices. These activities may include access to content, control of content, or coordinating transmission and/or receipt of the content, to name a few. When the devices perform their respective functions and with minimal coordination of activities between different devices, there may be overlap of activities, redundancies, and other such problems.

These problems are compounded when devices overlap in function and/or location (i.e., perform similar functions) or when new devices are being added to an existing federation. In these situations, the devices may have to be coordinated by intensive manual effort on the part of the user. Also, devices may not be able to communicate at all if one device requires a protocol or other functionality that may not be supported by other devices in the federation or vice versa. Thus, interoperability of a new device in the federation with existing devices in the federation may be compromised.

### SUMMARY

The following presents a simplified summary of the disclosure in order to provide a basic understanding to the reader. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

In one example, a method is provided for coordinating a service among federated devices in a network. Each of the devices in the network may be assigned a priority value based on a property of the corresponding device and a policy for providing the service may be based on the priority value.

In another example, the priority value may be based on relative locations of the devices in the network. For example, when a first device is within a first predetermined distance of a second device in the network, provision of the service may be assigned to the first or second device based on the corresponding priority values.

In yet another example, providing the service may change from a first device to a second device when the first device and the second device are within a predetermined distance of one another. Also, control of the providing of the service may be changed from one device to another based on relative locations of the devices.

Many of the attendant features will be more readily appreciated as the same becomes better understood by reference to the following detailed description considered in connection with the accompanying drawings.

### DESCRIPTION OF THE DRAWINGS

The present description will be better understood from the following detailed description read in light of the accompanying drawings, wherein:

FIG. 1 is a partial block diagram illustrating a network of federated devices.

FIG. 2 is a partial block diagram illustrates an example of a server managing federated devices in a network.

FIG. 3 is a partial block diagram illustrating an example of the server 101 of FIG. 1 or FIG. 2.

FIGS. 4A-4E illustrate an example of one implementation of the server for determining policies for interoperability of network devices.

FIG. 5 is a flowchart illustrating an example of coordinating federated devices in the performance of an action.

FIG. 6 is a flowchart illustrating another example of coordinating device function in a network of devices.

FIG. 7 is a flowchart illustrating an example of prioritizing devices in a network and coordinating activities of the devices based on the priorities.

FIG. 8 is a flowchart illustrating an example of adding a device into a federation.

Like reference numerals are used to designate like parts in the accompanying drawings.

### DETAILED DESCRIPTION

The detailed description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples.

A method and system for facilitating federation of user devices in a network is described.

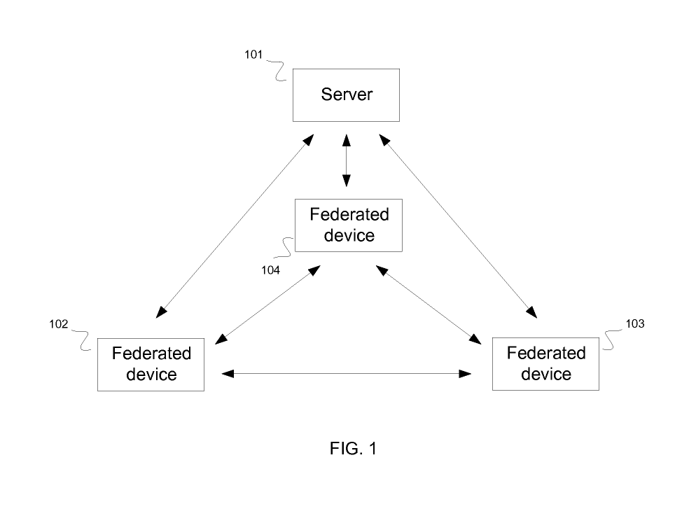

FIG. 1 is a partial block diagram illustrating an example of a network of federated devices and a server. The server 101 in this example communicates with each of the federated devices (102, 103, 104) in the network to coordinate activities among the federated devices. The server 101 may further be a federated device within the network. In an example of receiving media content and providing the media content to a user, federated device 102 may be a portable player that may receive media content and provide the media content at a local display. In addition, control of the media may be performed at the portable player (i.e., federated device 102). As the user of the portable player (federated device 102) roams, the portable player may approach another device in the network such as federated device 104. For example, federated device 104 may be a media player in an automobile and the user may enter the automobile with the portable player (federated device 102). Alternatively, the user may enter a house in which a media center is set up such as federated device 103. Each time the user approaches another device in the network (e.g., federated device 103 or federated device 104), presentation of the media may change to the other device or may continue to be displayed on the portable device (federated device 102). Also, control of the media presentation may be performed by any of the federated devices (102, 103, or 104, in this example) in the network.

In this example, the server 1 01 may communicate with each of the devices in the network to coordinate the functions of the devices in the network. The server 101 may centrally manage the federated devices (e.g., 102, 103, 104) so that each of the devices may perform desired functions in a unified fashion.

Alternatively, the media may be presented on a device in the federated network based on capabilities of the devices in the network. Federated device 102, which may be any type of device for providing media content, may be capable of presenting a video stream to a user but incapable of providing an audio stream. Federated device 103 may be capable of providing the audio stream and may or may not be capable of providing a video stream to the user. In this example, federated device 102 and federated device 103 may each provide a portion of the data such that the sum of the two federated devices (102 and 103) may provide the media content to the user substantially in its entirety (e.g., federated device 102 may provide the video component of the data and federated device 103 may provide the audio component of the data).

In another example, federated devices may be interconnected, either directly or indirectly, in a federated network while another device enters the network. The new device that enters the network may require certain protocols for functioning in a given task, identity or trust issues, or may have other interoperability issues. For example, the new device may use a proprietary codec that may not be supported by the other devices in the network. In this case, transcoding of the proprietary codec may be performed (e.g., by server 101) so that other devices in the network may play media from the new device using a codec common to the other devices in the network. Likewise, the new device may function with the other devices in the network as the server 101 manages the devices to agree on policies for sharing content and control presentation of the content.

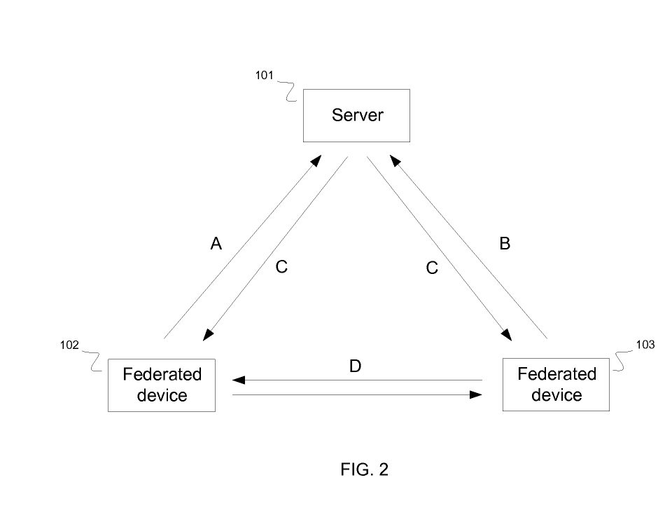

FIG. 2 illustrates an example of a server managing federated devices in a network. A user may wish to receive and control media data at federated device 102. Federated device 102 may be a mobile device such that the user may roam while receiving the media data. In Step A, the federated device 102 sends a message to the server 101 indicating that media data is desired at federated device 102. Federated device 102 may be the only federated device in the network. Therefore, the server 101 may respond in Step C by sending a coordinating message to federated device 102 to access the media data and present the media data to the user. In addition, control of the media may be performed at federated device 102.

If, for example, the user roams into the vicinity of federated device 103, then a network may form between federated device 102 and federated device 103. The server 101 may, for example, receive tracking information from federated device 102 (Step A) and may further receiving tracking information from federated device 103 (Step B). Based on the corresponding tracking data, the server 101 may determine if the federated devices (102, 103) are in the vicinity of each other (e.g., within a predetermined threshold distance of each other). Alternatively, the federated devices themselves may determine their proximity to each other by exchanging tracking information (Step D). When the federated devices (102, 103) are within a predetermined threshold distance of one another, federated device 102 and/or federated device 103 may send a message to the server 101 for coordination of the presentation and/or control of the media data.

In this case, an overlap exists between federated device 102 and federated device 103 in which either device may be capable of providing the media content and/or controlling the presentation of the media content to the user. The server 101 may then manage policies of the network to coordinate the activities and policies between the federated devices (102, 103) and/or resolve identity or trust issues of incoming devices into the network. Hence, server 101 may provide central management and other services for resolution of interoperability issues between the federated devices (102, 103) such that presentation and/or control of the media data may be effectively managed between the federated devices.

The server 101 may first determine if federated device 103 may enter the network. For example, a network may be accessible to devices that are authorized to access the network. Authorization to access the network of a device may be based on a trust level of the devices. Thus, the network may first authenticate a federated device when the federated device attempts to enter the network. Alternatively, the devices in the network may authenticate other devices. For example, when a new device attempts to enter the network, at least one of the federated devices may first authenticate the new device prior to permitting the new device to enter the network. The authentication of the federated device may be performed in a variety of ways and may be based on a variety of authentication or authorization criteria or trust/identity levels of the federated device. For example, devices having particular characteristics or properties may be authorized to access the network or the federated device may provide a password for entry into the network. Alternatively, the federated device may contain a trust level for indicating to the network devices or the server a level of trust for accessing the network. Any number of trust levels may be used. For example, trust may be a binary property (i.e., “trust” or “no-trust”) or a greater number of trust levels may be used such that the network of devices or the server may determine a minimum threshold trust level prior to allowing access to the network by the incoming federated device.

The server 101 may provide any additional service, if necessary, to integrate federated device 103 into the network. For example, federated device 103 may send a message in Step B to server 101 for requesting entry into the network. The request may include additional information for federated device 103 pertaining to the inclusion of federated device 103 in the network. For example, the additional information may include data on protocols supported by federated device 103 or codecs used by federated device 103. Likewise, the server 101 may receive similar characteristics of federated device 102 (Step A). If there are discrepancies between the protocols, codecs, etc. needed by either of the federated devices that may not be supported by the other federated devices, the server 101 may transcode data to permit sharing of data and control between the devices.

Hence, if federated device 103 is not capable of communicating at the media application layer, server 101 may perform functions to enable communication and interoperation with federated device 103. In one example to illustrate, federated device 103 may use a protocol or codec that may not be supported by federated device 102 (or vice versa). In this case, federated device 103 may not be able to communicate with federated device 102 to provide for presentation or control of the media data. Server 101 may provide transcoding of the codec so that the federated devices (102, 103) may communicate and interoperate in the network.

The server 101 may thus receive information on the respective federated device in the network pertaining to procotols, tracking information, or other interoperability services for coordinating the functions of the federated devices from the federated devices. Based on the information received from the federated devices, the server 101 may transmit messages (Step C) to the federated devices (102, 103) for coordinating the presentation and/or control of the media data.

In an example to illustrate, federated device 102 may be a mobile device and may present and control media data locally to the user. This activity may be coordinated by server 101 after federated device 102 sends information (e.g., protocol information, location information, etc.) in Step A and server 101 sends a message to the mobile device (Step B) to permit the display and control of the media data. The server 101 may further detect when the user enters the vicinity of a media center (e.g., federated device 103). For example, federated device 103 may transmit a message to the server 101 to inform the server 101 of its location. Alternatively, federated device 103 (a media center, in this example) may have previously provided this information to the server 101 which may be stored in memory and accessed when federated device 102 is detected to be in the vicinity of federated device 103 (i.e., within a predetermined threshold distance).

When the mobile device (federated device 102) enters to within the predetermined threshold distance of the media center (federated device 103), the server 101 may determine interoperability needs of federated device 103 and compare the interoperability needs of federated device 103 with those of federated device 102. If necessary, the server 101 may provide any interoperability services necessary (e.g., transcode incompatible codecs, etc.). The server 101 further sends messages to either of the federated devices 102, 103 (Step C) to facilitate agreement between the federated devices on policies for sharing and control.

The agreement between the federated devices may be based on a variety of factors. For example, a policy may be stored at the server 101 for determining which federated device controls the presentation of the media data or which federated device presents the media data to the user. This may be based on any number of predetermined policies which may be stored at the server 101. For example, the server 101 may contain a policy for presenting the media data on the media center when the mobile device is within a predetermined distance of the media center. The Table below illustrates this example. As shown in the Table, there are two federated devices represented by “1” and “2” in columns 3 and 4 of the Table. The two federated devices may be located within a first distance (Distance 1, column 1) or within a second distance (Distance 2, column 2), where the first distance (Distance 1) is greater than the second distance (Distance 2).

When the first and the second federated devices are greater than Distance 1 from each other, then control and presentation of the media data is performed at the first federated device “1” (line 1 of the Table). Because Distance 1 is greater than Distance 2 in this example, if the two federated devices are separated by a distance greater than Distance 1, then the two federated devices are also separated by a distance greater than Distance 2. Thus, if the first federated device is a mobile terminal and the second federated device is a media center, then when the mobile terminal is greater than a distance 1 from the media center, then the mobile terminal is also greater than a distance 2 from the media center. Also, the mobile terminal presents the media data and provides control of the media data.

When the user roams to within a distance 1 of the media center (see Table, line 2), but still outside of distance 2 from the media center, the mobile device continues to provide the control of the media data playback but the media data is presented at the media center rather than the mobile device. For example, when a user is in the same room as the media center, the display of the media data changes from the small display on the mobile device to the larger display of the media center. However, if the mobile device is farther away from the media center than a predetermined shorter distance (i.e., distance 2), control of the media data playback remains with the mobile device. For example, if the user is within the same room as the media center but not yet close enough to the media center to control it. In this case, the user may control the playback through the operations of the mobile device.

In the third scenario, the user is within distance 2 of the media center (table, line 3). In this case, the user is close to the media center such that the presentation of the media data continues at the media center but the control of the media data playback also changes to the media center. Therefore, in this example, the user may control playback of the media data through control of the media center devices. The mobile device, having passed presentation function and control function to the media center may await further instructions from server 101. For example, if the user then moves away from the media center with the mobile device to a distance greater than distance 2, then the location of the mobile device may be tracked at the server 101 via paths A and C (FIG. 2) and the corresponding location of the media center via paths B and C. Control of the playback of the media data may switch back to the mobile device based on the relative locations of the mobile device and the media center. If the user moves further away from the media center to a distance that is greater than or equal to distance 1, then both presentation and control may shift to the mobile terminal or device.

TABLE

| Within Distance 1 | Within Distance 2 | Presentation | Control |
|---|---|---|---|
| No | No | 1 | 1 |
| Yes | No | 2 | 1 |
| Yes | Yes | 2 | 2 |

In the example described above, coordination of the federated devices in the network is based on relative location of the federated devices, however, any criteria or desired policy may be used in coordinating the function of the federated devices. For example, capabilities of the individual devices in the network may be stored in the server and priority may be assigned by the server to each of the devices based on the capabilities of the devices. If one device contains a high resolution display while a second device contains a low resolution display, then if the media data for presentation contains high resolution display material and the two devices overlap, the server may permit the first device to display the media data. Likewise, if one device contains a small form factor display while a second display contains a large display, the server may permit the device containing the large display to display the media data.

In addition, the priorities assigned to the each of the devices in the network may be based on user preferences. For example, if a first device has a low-resolution large display and a second device has a high-resolution small display, then when the first and second devices overlap, the server may permit either the first or second device to display the media data based on user preference. If the user prefers larger displays even if at lower resolution, then the server may permit the first device to display the media data. If the user prefers high resolution images even if on a small display, then the server may permit the second device to display the media data. The user preferences and characteristics may be collected and stored in a database at the server or in the device itself.

In another example, any of the devices in the network may store additional information, such as schemas or other information pertaining to capabilities of the device or usages of the device or information for common tasks (e.g., communications, media review, control at a distance or monitoring, to name a few). Any of the device information may be accessible by a central device such as a hub or server such that the devices may form an ad hoc network for accomplishing a task. Hence, a group of devices may “morph” in real-time into a system or network of devices for providing a desired function.

As one example to illustrate, devices may be located at a particular location where the devices may participate in a communications function. When a user desires to perform the function (e.g., communications function), the devices in the vicinity may form a network to enable the user to communicate. Thus, in an example of communication, a user may be at a location containing a camera, speakers, a cell phone, and an IP phone. When a call is received at the location, a hub or server may sense the incoming call and may further access schemas and other information stored at the respective devices. Based on the accessed information, the hub or server may facilitate “morphing” of the devices into a network for communication. For example, the hub or server may instruct the camera to re-orient and to capture images of the user. The captured images, which may include video or still images, may be received at the hub or server. Based on the information (e.g., schemas, capability information, etc.) stored at the speakers, the hub or server may determine that the speakers have audio capability and may thus instruct the speakers to capture audio signals. Similarly, the hub or server may receiving information regarding any of the devices at the location and may instruct the corresponding devices accordingly. This may include, for example, instructing a microphone (e.g., of the cell phone) to capture sound or voice information from the user. The captured sound or voice information may further be transmitted to the caller. Also in this example, the call may further be routed through the IP telephone based on the capabilities of the IP telephone.

Thus, in this example, activities of devices may be coordinated to perform an orchestrated function. The devices may be coordinated by a hub, server or other similar device based on capability data or schemas stored at the devices. The capability data or schemas may be accessed by the hub, server or other similar device and, based on the data or schemas, the hub, server or other similar device may control capable devices to perform desired functions as a group. Additionally, the needs of the process may be represented such that capabilities and other information of the devices may be matched with needs of the process. Such needs may also be prioritized such that low priority needs may be skipped, if desired.

In another example, a computing system containing a pointing device (e.g., mouse, light pen, stylus, etc) may include different components that may function as a single group based on capabilities or schemas stored at each component in the computing system. In this example, the computing system may also include a surveillance camera for tracking movement of the pointing device, a display for displaying a cursor, speakers or other audio-producing apparatus, internet connection, etc. A hub or server may receive or may access information for each of the devices. For example, each device or component may include a schema or capability information stored locally. Alternatively, the information may be stored remotely.

Based on the accessed information, the hub or server may instruct or inform the devices accordingly. Based on the actions of the hub or server, the devices may coalesce into a group of devices (i.e., in a federated network) functioning together to perform a concerted task. In this case, the camera detects movement of the mouse which controls movement of the cursor on the display. Also, the speakers or other audio-generating device may provide sound and the internet connection may connect the device and the user to a remote site, if desired. Thus, the hub or server may control the devices in the federated network to function as a group. The hub or server may control the devices, the control of which may be based on the capabilities of the devices stored at locally at the devices or stored remotely and accessed by the hub or server.

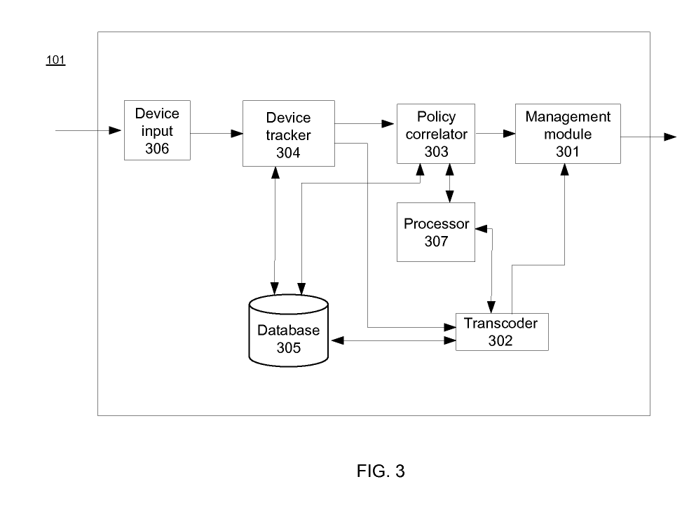

FIG. 3 is a partial block diagram illustrating an example of the server 101 of FIG. 1 or FIG. 2. The server 101 may include a device input 306 for receiving input from any remote device. A federated device in a network may send a message to the server 101 which may receive the message via the device input 306. The message from the federated device may be further processed at a device tracker 304 for identifying the location of the device. For example, the device may include location information in the message sent to the server 101. Based on the location information received from the device, the server may identify the location of the device. Alternatively, the device may contain a tracking device to permit automatic tracking of the device at the server. The server may receive periodic information from the device indicating a location of the device. Location information for any of the federated device may be further stored in a database 305.

In addition, the database 305 may contain policies for coordinating activity of multiple federated devices in a network. The device input 306 may receive a message from a federated device in a network indicating media data to be received and presented on a device. A processor may process the message to determine a matching policy corresponding to the federated device and the requested function from the federated device. Also, a policy may be determined based on characteristics of the user. For example, user preferences may be stored in the database 305 such that the processor 307 may determine a policy for coordinating a function based on the stored characteristics of the user. Alternatively, a message may be received from the user via the device input 306 which may include a preference for a policy for coordinating the function.

Based on the policy for coordination of the function (e.g., presentation and control of media data), the processor 307 may activate a policy correlator 303 and/or transcoder 302 of the server 101. The policy correlator 303 receives information from the database 305 and/or device tracker 304 to determine the policy for controlling or coordinating the function among the federated devices. In one example, the policy correlator 303 receives multiple preferences and/or characteristics of the federated devices and/or user and integrates the characteristics into controls for implementing a coordinated experience. In another example, multiple policies may be received at the policy correlator 303 such that the policy correlator 303 determines a combination of policies and/or protocols for enhancing communication among the federated devices in the network.

Also, additional interoperability may be needed for correlating or coordinating the activity of each of the federated devices as a whole in the network. For example, one federated device may use a proprietary codec that may not be supported by at least one other device in the network. The transcoder 302 of the server 101 may transcode the proprietary codec to allow other devices to communicate and play media from the device that uses the proprietary codec. In addition, any other interoperability service may be performed by the server 101 or transcoder 302 to enhance interoperability of the federated devices.

The server 101 may further include a management module 301 for managing the interaction and interoperability of the federated device in the network. The management module 301 receives the correlated policy from the policy correlator 303 and determines the federated device for performing a desired function. The management module 301 may further receive transcoded data from the transcoder 302 for enhancing interoperability of the devices. Based on the received information (e.g., policy information from the policy correlator 303), the management module 301 may determine the policy to apply to the federated devices and may control the federated devices so that a desired device may present the data and/or control the presentation of the data.

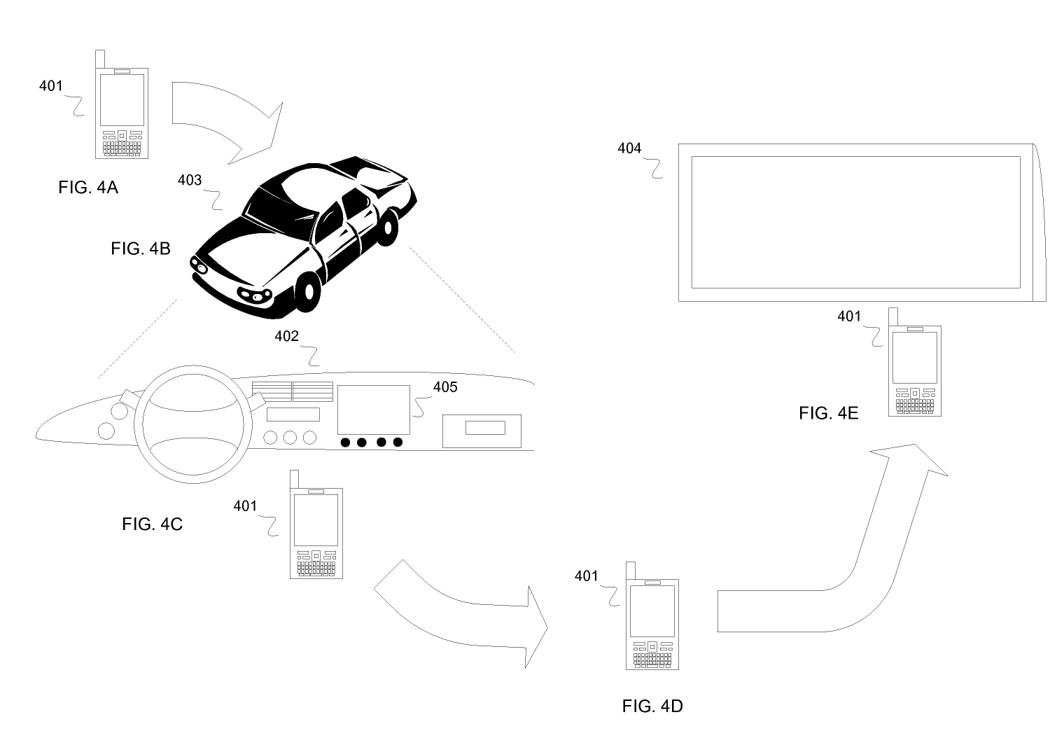

FIGS. 4A-4E illustrate an example of one implementation of the server for determining policies for interoperability of network devices. As FIG. 4A illustrates, a wireless device may provide functionality for presenting and controlling media data. A user may receive media data on the wireless device 401 and may also control the presentation of the media data on the wireless device 401 by inputting commands into the wireless device 401.

FIG. 4B illustrates an automobile with which a user may use to receive the media data and/or control the presentation of the media data. FIG. 4C illustrates an enlarged view of the dashboard of the automobile illustrated in FIG. 4B. As FIG. 4C illustrates, automobile 403 has a dashboard 402 that contains a media player 405. When the user enters the automobile 403 with the wireless device 401, the media data playing on the wireless device 401 may continue playing on the wireless device 401, may switch to play only on the media player 405 of the automobile 403 or may play simultaneously on the wireless device 401 and the automobile's 403 media player 405. Also, control of the playback of the media data may be performed by the wireless device 401, the media player 405 or both. Such activities may be coordinated by a server (not shown).

In this example, a server (not shown) may determine a desired coordination of the devices (i.e., the wireless device 401 and the media player 405). The wireless device 401 sends a message to the server to indicate characteristics of the wireless device 401 such as capabilities, supported protocols, codecs, and/or location, to name a few. The server may further receive information from the media player 405 pertaining to similar characteristics of the media player 405. Any of the information may be stored in memory at the server or remote from the server.

The user may enter the automobile 403 with the wireless device 401. The server receives a message from the wireless device 401 indicating that the wireless device 401 is within a predetermined threshold distance from the media player 405. Based on this relative location information and/or other information (e.g., protocols, capabilities, etc), the server may determine a desired coordination of the functions of the wireless device 401 and the media player 405. For example, the server may permit the presentation of the media data to switch from the mobile device 401 to the media player 405. In this case, the server sends a message to the mobile device 401. Responsive to receipt of the message from the server, the mobile device 401 may discontinue displaying the media data. At substantially the same time, the server may send a message to the media player 405 to instruct the media player to display the media data. Similarly, control of the playback of the media data may switch from the wireless device 401 to the media player 405. For example, based on information received from each of the devices (wireless device 401 and media player 405), the server may correlate relevant policies and provide, via a central management module for example, control information or instructions to each of the federated devices so that activity of each of the devices (in this case, the wireless device 401 and media player 405) may be effectively coordinated.

FIG. 4D illustrates that the user exits the automobile 403 with the wireless device 401. In this case, the wireless device 401 is removed from the automobile 403. Location information may be received at the server to determine that the wireless device 401 is no longer in the vicinity of the media player 405 of the automobile 403. In this case, the wireless device 401 may send a message to the server. The message may further contain location information so that the server may track the location of the wireless device. Also, the media player 405 may send a message to the server to indicate a relative location from the wireless device 401. If the distance between the wireless device 401 and the media player 405 is greater than a predetermined threshold value, then the presentation of the media data may switch from the media player 405 of the automobile 403 to the wireless device 401. Also, control of the playback of the media data may switch to the wireless device 401 from the media player 405.

FIG. 4E illustrates the user in the vicinity of a large display device in a media center 404. For example, the user may enter a home containing a media center with a large display device for displaying media data. As the user approaches the media center device 404 with the wireless device, a message from the wireless device 401 and/or the media center device 404 may be sent to the server. The server processes received messages from the wireless device 401 and the media center device 404 and determines relative locations of the devices. In this example, the server may determine that the wireless device 401 is within a predetermined threshold distance from the media center device 404. Based on the messages received from the respective devices, the server may send control information and messages to the federated devices (wireless device 401 and media center device 404) to coordinate the presentation and/or control of the media data on the devices. For example, the server may send a control message to the wireless device 401 when the wireless device 401 is within a first predetermined distance of the media center device 404 to pass presentation of the media data to the media center device 404. The wireless device 401, responsive to the control message from the server, discontinues the presentation of the media data and passes the presentation of the media data to the media center device 404. Alternatively, the server may send a further message to the media center device 404 to activate the media center device 404 to present the media data. Similarly, control of playback of the media data may pass from the wireless device 401 to the media center device 404.

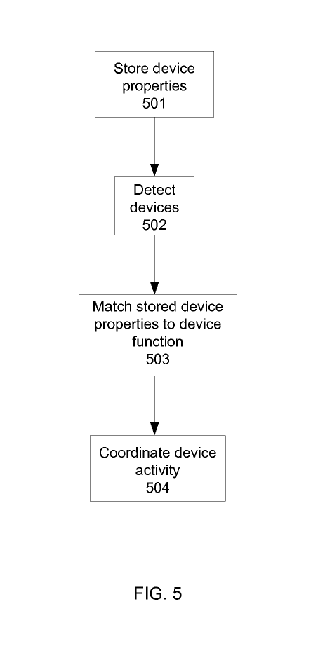

FIG. 5 is a flowchart illustrating an example of coordinating federated devices in the performance of an action. A server may receive information pertaining to characteristics of federated devices in a network (STEP 501). For example, a wireless device may transmit a message to the server including characteristic information of the wireless device such as location information, capabilities, languages, etc. The server may receive such information on the characteristics for each of the devices in the network and may further store the information in a database (STEP 501). The information may be accessed as desired for obtaining information on federated devices in the network for coordination of the devices.

In STEP 502, the server detects a federated device in a network. The federated device, for example, may send a message to the server indicating the presence and location of the device. The server receives the message from the device and may identify the device as a federated device in a network. The server may further match the information corresponding to the device with stored information in the database (STEP 503). Similarly, other devices in the network may send messages to the server including information and/or location data corresponding to each of the respective devices. The server matches each device in the network with information in the database pertaining to device characteristics including the functions of each of the devices (STEP 503).

Based on the information received in each of the messages from each of the federated devices in the network and the corresponding information for each of the devices obtained from the database, the server coordinates the activity of each of the devices with other devices in the network (STEP 504). For example, the server may determine that a first federated device is a portable wireless display device that is within a predetermined threshold distance of a large display in a media center. The server may transmit control messages and may provide other interoperability services to the devices (e.g., transcoding of codecs, etc.) to facilitate the coordination of the activities of each of the devices in the network. In one example, the presentation of media data may be switched from one device in the network to another device in the network. Likewise, control of the playback of the media data may also be transferred to another device in the network.

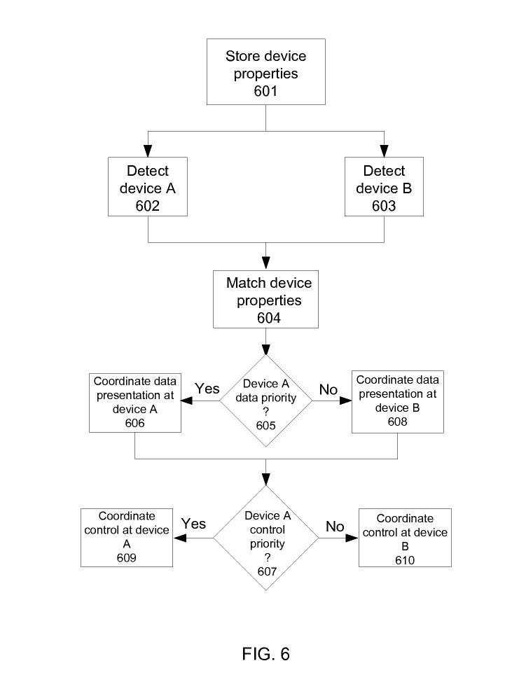

FIG. 6 is a flowchart illustrating another example of coordinating device function in a network of devices. In STEP 601, a server receives properties and characteristics of a device in the network. The server may further receive similar information from each of the devices in the network. In this example, two devices—device A and device B—are in the network. Each of the devices sends a message to the server. Based on the received messages, the server detects each of the devices as devices in the federated network of devices (STEPS 602, 603). The messages contain additional information pertaining to the devices themselves such as capabilities of each of the devices or priority of the devices in the network. The priority information for each of the devices may provide a hierarchy of each of the devices in the network for presenting media data and/or controlling the presentation of the media data. For example, a device with a high priority will more likely be selected to be the device to present and/or control the media data. If a device assigned a high priority and another device assigned a low priority are federated devices in the network, then the high priority device presents and/or controls the presentation of the media data rather than the lower priority device.

In STEP 604, device properties are compared to determine a device with higher priority. If device A has higher priority than device B (“YES” branch of STEP 605), then device A presents the media data (STEP 606). However, if device B has a higher priority than device A (“NO” branch of STEP 605), then device B presents the media data (STEP 608). The server may send a control message to each of device A and device B to coordinate the devices such that the higher priority device presents the media data. For example, when a handheld wireless display device and a large display in a media center are within a predetermined threshold distance of each other, the large display in the media center may have a higher assigned priority. In this example, the large display has a higher priority so that whenever the handheld wireless display device is within a certain predetermined threshold distance of the large display, the large display presents the data. The priority may be set or altered as desired based on individual preferences of the user. For example, if a user prefers a handheld device over the large display, the priority rules for governing policies for controlling and coordinating devices may be altered accordingly.

In STEP 607, a priority corresponding to control the presentation of the media data is compared between device A and device B. Based on the respective assigned control priorities of the devices, control of the playback of the media data may be provided by device A or device B. If the control priority of device A is higher than the control priority of device B (“YES” branch of STEP 607), then device A controls the playback of the media data (STEP 609). Conversely, if the control priority of device B is higher than the control priority of device A (“NO” branch of STEP 607), then device A control the playback of the media data (STEP 610). The control priority may be determined in a variety of ways. For example, a user preference may be received from a user and, based on the user preference, a particular value of control priority may be assigned to a corresponding device. If more than two devices are present in the network, then each of the data priority and/or control priority values for each of the devices may be assigned a value that may differ relatively from values assigned to other devices. Thus, the priority of each of the devices in the plurality of devices is assigned relative to each of the other devices. In this way, if there are a large number of devices in the federated network, then any subset of the federated devices may be present and participating in the network at any given time. Each of the federated devices in the subset of federated devices may likewise present media data and/or control the presentation of the media data based on each of their respective priorities.

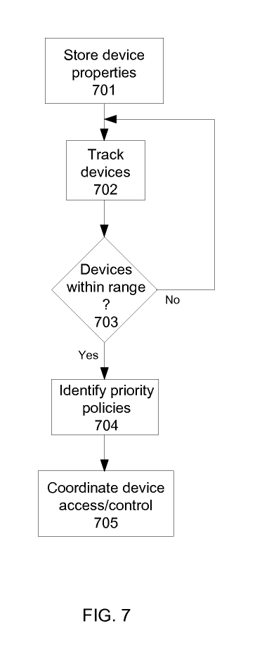

FIG. 7 is a flowchart illustrating another example of prioritizing devices in a network and coordinating activities of the devices based on the priorities. In STEP 701, properties of federated devices are stored. A server may receive data from the federated devices pertaining to characteristics or properties of the devices. For example, a device may send a message to the server containing information of capabilities of the device (video capabilities, audio capabilities, etc.). The server receives such information from any of the devices in the network and may store this information. This information may further be used to determine priorities of the devices in the network.

In STEP 702, locations of the devices are tracked at the server. Tracking of the locations of the devices may be accomplished in a variety of ways. In one example, federated devices may send messages to the server including an indication of a location at which the federated devices are location. Alternatively, the federated devices may contain tracking devices in which the server may locate each federated device in the network.

Based on tracking of the devices, the server determines if devices are within range (STEP 703). For example if a first federated device is a handheld wireless display device, a user may carry the first federated device while roaming. A second federated device may be a stationary display device in a media center. The respective locations of the first and second federated devices are tracked at the server as the first federated device moves relative to the second federated device (“NO” branch of STEP 703). When the first federated device is detected to be within a predetermined distance from the second federated device (“YES” branch of STEP 703), the server may identify priority policies based on various factors (STEP 704) including, for example, characteristics or properties of the devices or the user.

In one example, the server may have a database that stores properties of federated devices in a network or characteristics or preferences of users in the network. Properties of federated devices may include capabilities of the devices, hardware features, availability, etc. Based on the properties for the corresponding devices, the server may determine a policy for coordinating the activity (e.g., display and control of media data) among the federated devices in the network (STEP 705). The server may further provide additional interoperability services such as transcoding of data between devices in the network. In addition, the process of determining the policy may be repeated as needed. For example, an additional device may be included in the network and the policy may be updated to include the additional device. Also, characteristics or properties of the devices may change which may result in a change or modification of priority policies.

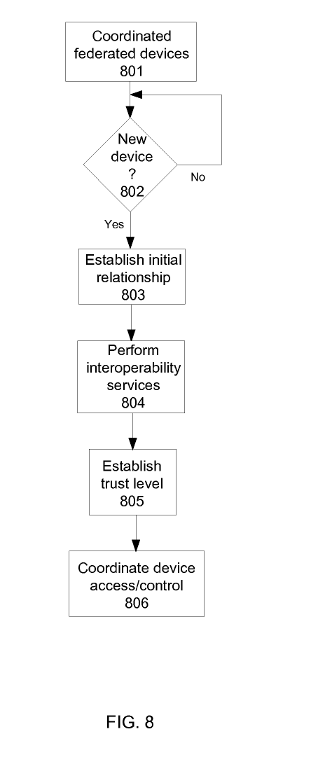

FIG. 8 is a flowchart illustrating an example of adding a device into a federation. In STEP 801, a network of federated devices is providing services to a user such as presentation and control of media data. The presentation and control of media data is coordinated among the federated devices in the network by a coordinating entity such as a server. In this example, a new device enters the network (STEP 802). When the new device enters the network (“YES” branch of STEP 802), the server establishes an initial relationship between the new device and the other federated devices in the network (STEP 803). For example, the new device may send a message to the server requesting entry into the federated network. The server receives the message from the new device and determines characteristics, properties or requirements of the new device. For example, if the new device uses a proprietary codec that is not supported by the other federated devices in the network, the server may provide interoperability services (STEP 804) such as transcoding of the proprietary codec such that the new device may communicate in the federated network. Also, a trust level may be established for the new device (STEP 805). In one example, the new device is determined as either trustworthy or not trustworthy. Hence, a binary property may be assigned to the new device as “trust” or “no-trust.” In another example, additional trust levels may be assigned to a new devices. The new device may be assigned one of three trust levels, e.g., a “high trust” level, “medium trust” level, or “low trust level.” These are merely examples as any number of trust levels may be assigned (e.g., four, five, six, seven, eight, nine, ten, or more than ten trust levels).

The above process may be repeated, for example, to update the devices in the network or to include additional devices in the network. Also, the server may receive information on the characteristics and properties of the new device and store the information in memory. Based on the information, the server may determine the capabilities of the new device and a priority in view of the priorities of the other federated devices in the network. The server may further determine policies for the coordination of the devices corresponding to the priorities of each of the federated devices (STEP 806). The policies may be stored in memory.

For example, the server may manage the federated devices (e.g., by transmitting control messages to each of the devices) such that a federated device with a high priority for presentation of media data presents the media data rather than a federated device with a lower priority. Presentation and control of media data may thus be coordinated among the federated devices in the network and the new device (STEP 804) based on the respective relative priorities of the devices and policies governing the coordination of the devices.

It is understood that aspects of the present invention can take many forms and embodiments. The embodiments shown herein are intended to illustrate rather than to limit the invention, it being appreciated that variations may be made without departing from the spirit of the scope of the invention. Although illustrative embodiments of the invention have been shown and described, a wide range of modification, change and substitution is intended in the foregoing disclosure and in some instances some features of the present invention may be employed without a corresponding use of the other features. Accordingly, it is appropriate that the appended claims be construed broadly and in a manner consistent with the scope of the invention.

1. A method for coordinating a service among a plurality of devices comprising:
determining a policy for coordinated operation of the plurality of devices in delivery of the service;
coordinating the service among the plurality of devices based on the policy.

2. The method of claim 1 wherein the step of determining the policy includes:
identifying a priority value of each of the devices based on a device property;
determining a policy for delivery of the service based on the relative value of the priority value of each of the devices.

3. The method of claim 2 wherein the step of identifying a priority value includes:
receiving a property of a device from the device;
assigning a priority value to each of the devices based on the property received from a corresponding device.

4. The method of claim 3 wherein the property includes at least one of device capability, availability, user preference, location, identity, trust level, and size.

5. The method of claim 4 wherein the step of determining a policy includes determining a distance between a first device and a second device, the first device providing the service.

6. The method of claim 5 wherein the distance between the first device and the second device is less than or equal to a first predetermined threshold value.

7. The method of claim 6 wherein the step of coordinating the service includes providing the service on the second device.

8. The method of claim 6 wherein the distance between the first device and the second device is less than or equal to a second predetermined threshold value, the second predetermined threshold value being less than the first predetermined threshold value.

9. The method of claim 8 wherein the step of coordinating the service includes providing the service on the second device and providing control of the service on the second device.

10. The method of claim 1 wherein the service comprises providing media data.

11. The method of claim 1 wherein the step of coordinating the service includes transmitting a message to each device in the plurality of devices, the message causing agreement in providing the service between the devices in the plurality of device.

12. The method of claim 111 wherein the message causes providing the service to change from a first device in the plurality of devices to a second device in the plurality of devices.

13. The method of claim 12 wherein the message further causes control of providing the service to change from the first device to the second device.

14. The method of claim 1 further comprising transcoding data for the devices.

15. The method of claim 1 wherein the service is providing media data and the step of determining the policy includes:
tracking a location of a first device and a second device in the plurality of devices;
identifying a priority value of the first device and the second device, each priority value being based on the tracked location of a corresponding device;
assigning the corresponding priority value to each of the first device and the second device based on a relative location of the first and second device.

16. The method of claim 15 wherein the relative location of the first and second device includes a distance between the first and second devices being less than a first predetermined location and wherein the coordinating step includes at least one of changing from providing the service to the first device to providing the service to the second device and changing control of providing the service from the first device to the second device.

17. The method of claim 1 further comprising:
receiving a request from a device to participate in coordinating the service among the plurality of devices; and
authenticating the device;
wherein the device is capable of participating in coordinating the service among the plurality of devices after the authenticating step and wherein the authenticating includes identifying the device as permitted to participate in the coordination by at least one of the devices in the plurality of devices.

18. An apparatus for coordinating delivery of a media service among a plurality of devices in a federated network, the apparatus comprising:
a policy correlator for determining a policy for coordinating the plurality of devices in one of delivering and controlling the media service; and
a management module for coordinating one of delivery and control of the media service among the plurality of devices based on the policy.

19. The apparatus of claim 18 further comprising a device tracker for determining relative locations of the devices in the federated network, the policy correlator further determining the policy based on a distance between the devices in the federated network, and the management module causing a device in the plurality of devices to one of display and control the media service based on the distances between the devices.

20. The apparatus of claim 18 wherein the policy correlator determines the policy based on corresponding priority values assigned to the devices in the plurality of devices, the priority values based on corresponding device properties, and wherein the management module coordinates the device associated with a highest value of priority value to provide the media service.
